(19) United States
(12) Patent Application Publication
(10) Pub. No.: US 2016/0056462 A1
(43) Pub. Date: Feb. 25, 2016

(54) CATHODE ACTIVE MATERIAL

(71) Applicant: Asahi Glass Company, Limited, Tokyo (JP)

(72) Inventors: Tomohiro SAKAI, Tokyo (JP); Tsubasa TAKASUGI, Tokyo (JP); Takuya TERATANI, Tokyo (JP)

(73) Assignee: Asahi Glass Company, Limited, Tokyo (JP)

(21) Appl. No.: 14/930,679

(22) Filed: Nov. 3, 2015

Related U.S. Application Data
(63) Continuation of application No. PCT/JP2014/064002, filed on May 27, 2014.

(30) Foreign Application Priority Data
May 28, 2013 (JP) 2013-112127

(51) Int. Cl. H01M 4/505; H01M 4/525

(52) U.S. Cl. CPC H01M 4/505; H01M 4/525; H01M 2004/028

(57) ABSTRACT

To provide a cathode active material which achieves a high discharge capacity and excellent cycle durability.

A cathode active material represented by LiₐMOₓ (wherein M is an element including at least one member selected from Ni element, Co element and Mn element (other than Li element and O element), “a” is from 1.1 to 1.7, and x is the number of moles of O element required to satisfy the valences of Li element and M),
wherein in an X-ray diffraction pattern, the ratio (I/r) of the crystallite size (I) of (003) plane to the crystallite size (r) of (110) plane assigned to a crystal structure with space group R-3m is at least 2.6.

This application is a continuation of PCT Application No. PCT/JP2014/064002, filed on May 27, 2014, which is based upon and claims the benefit of priority from Japanese Patent Application No. 2013-112127 filed on May 28, 2013. The contents of those applications are incorporated herein by reference in their entireties.

### TECHNICAL FIELD

The present invention relates to a cathode active material to be used for a positive electrode of a lithium ion secondary battery having a high discharge capacity and favorable cycle durability.

### BACKGROUND ART

Lithium ion secondary batteries have been widely used for e.g. portable electronic instruments such as mobile phones and notebook personal computers.

For a positive electrode of a lithium ion secondary battery, as a cathode active material, a composite oxide containing Li element and a transition metal element has been used. As such a cathode active material, for example, LiCoO₂, LiNiO₂ or LiNi_{0.8}Co_{0.2}O₂ has been known. Such a cathode active material has a low proportion of Li element based on the transition metal element in the composite oxide.

In recent years, for a lithium ion secondary battery for portable electronic instruments or for vehicles, demands for downsizing and weight saving are increasing. Accordingly, a cathode active material which satisfies, when used for a positive electrode of a lithium ion secondary battery, both high discharge capacity per unit mass and a property such that after a charge and discharge cycle is repeatedly carried out, the discharge capacity hardly decreases (hereinafter sometimes referred to as cycle durability), has been required.

As a cathode active material having favorable cycle durability, Patent Document 1 proposes used of a cathode active material comprising secondary particles having primary particles having an aspect ratio of at least 2.0 and at most 10.0 agglomerated, wherein in powder X-ray diffraction measurement using CuKα rays, 0.10°≦FWHM110≦0.30° is satisfied, where FWHM110 is the full width at half maximum of a 110 diffraction peak present within a range of diffraction angle 2θ of 64.5°±1.0°. However, since this cathode active material is not a cathode active material having high contents of Li element and Mn element (hereinafter sometimes referred to as a lithium/manganese rich cathode active material), its discharge capacity is not sufficiently high.

### PRIOR ART DOCUMENT

### Patent Document

Patent Document 1: WO2012/124240

### DISCLOSURE OF INVENTION

### Technical Problem

The object of the present invention is to provide a cathode active material to be used for a positive electrode of a lithium ion secondary battery having a high discharge capacity and favorable cycle durability.

### Solution to Problem

To achieve the above object, the present inventors have conducted extensive studies and as a result, found that structural stability of a lithium/manganese rich cathode active material can be increased by controlling the form of the crystallite.

That is, the present invention provides the following.
[1] A cathode active material represented by LiₐMOₓ (wherein M is an element including at least one member selected from Ni element, Co element and Mn element (other than Li element and O element), “a” is from 1.1 to 1.7, and x is the number of moles of O element required to satisfy the valences of (I/r) element and M),

wherein in an X-ray diffraction pattern, the ratio (I/r) of the crystallite size (I) of (003) plane to the crystallite size (r) of (110) plane assigned to a crystal structure with space group R-3m is at least 2.6.
[2] The cathode active material according to the above [1], wherein the molar proportion of Ni is from 10 to 50%, the molar proportion of Co is from 0 to 33.3%, and the molar proportion of Mn is from 33.3 to 85% based on the total amount of Ni, Co and Mn elements other than Li contained in the lithium-containing composite oxide.
[3] The cathode active material according to the above [1] or [2], which is represented by LiₐNi_{α}Co_{β}Mn_{γ}Oₓ (wherein “a” is from 1.1 to 1.7, α is from 0.1 to 0.5, β is from 0 to 0.33, γ is from 0.34 to 0.85, α+β+γ=1, and x is the molar ratio of O element required to satisfy the valences of Li, Ni, Co and Mn).
[4] The cathode active material according to any one of the above [1] to [3], wherein the crystallite size (I) is from 40 to 200 nm, and the crystallite size (r) is from 5 to 80 nm.
[5] The cathode active material according to any one of the above [1] to [4], wherein the particle size D₅₀ of the cathode active material is from 3 to 15 μm.
[6] The cathode active material according to any one of the above [1] to [5], wherein the specific surface area of the cathode active material is from 0.1 to 10 m²/g.
[7] The cathode active material according to any one of the above [1] to [6], wherein the average particle size of primary particles corresponding to a circle is from 10 to 1,000 nm.
[8] The cathode active material according to any one of the above [1] to [7], wherein the ratio D₉₀/D₁₀ of the particle size D₉₀ to the particle size D₁₀ of the cathode active material is from 1 to 2.4.
[9] The cathode active material according to any one of the above [1] to [8], wherein in an X-ray diffraction pattern, the ratio (I₀₂₀/I₀₀₃) of the integrated intensity (I₀₂₀) of a peak of (020) plane assigned to a crystal structure with space group C2/m to the integrated intensity (I003) of a peak of (003) plane assigned to a crystal structure with space group R-3m is from 0.02 to 0.3.

### Advantageous Effects of Invention

According to the cathode active material of the present invention, the discharge capacity of a lithium ion secondary battery can be increased, and the cycle durability can be improved.

### BRIEF DESCRIPTION OF DRAWING

FIG. 1 is a graph illustrating the relation between l/r and the capacity retention in Examples and Comparative Examples.

### DESCRIPTION OF EMBODIMENTS

In this specification, “Li” means Li element, not a metal. The same applies to other descriptions such as Ni, Co and Mn. Further, the proportion of element in a lithium-containing composite oxide as described hereinafter is a value in a lithium-containing composite oxide before initial charge (also called activation treatment).

### [Cathode Active Material]

The cathode active material of the present invention comprises a lithium-containing composite oxide represented by the formula (1):

LiₐMOₓ (1)

wherein M is an element including at least one member selected from Ni, Co and Mn (other than Li and O), “a” is from 1.1 to 1.7, and x is the number of moles of O element required to satisfy the valencies of Li and M.

Hereinafter a transition metal element including at least one member selected from Ni, Co and Mn will sometimes be generally referred to as a transition metal element (X).

The cathode active material of the present invention has at least a layered rock salt crystal structure with space group R-3m. The cathode active material is preferably one having a layered rock salt crystal structure with space group R-3m and a layered rock salt crystal structure with space group C2/m.

The cathode active material of the present invention is preferably a solid solution of a compound having a layered rock salt crystal structure with space group R-3m and a layered rock salt crystal structure with space group C2/m. Further, the crystal structure with space group C2/m is also called lithium excess phase.

The cathode active material of the present invention preferably satisfies, in an X-ray diffraction pattern, a ratio (I₀₂₀/I₀₀₃) of the integrated intensity (I₀₂₀) of a peak of (020) plane assigned to the crystal structure with space group C2/m to the integrated intensity (I₀₀₃) of a peak of (003) plane assigned to the crystal structure with space group R-3m of from 0.02 to 0.3, whereby the cathode active material of the present invention has a high discharge capacity.

In a crystallite having a layered rock salt crystal structure with space group R-3m, at the time of charge and discharge, each Li diffuses in the a-b axis direction in the same layer, and Li ion is inserted and removed at the end of the crystallite. The c-axis direction of the crystallite is the laminating direction, and in a shape long in the c-axis direction, the number of ends at which Li ion is inserted and removed increases as compared with another crystallite having the same volume. The crystallite size in the a-b axis direction can be calculated from the crystallite size (r) of (110) plane with space group R-3m, and the size in the c-axis direction can be calculated from the crystallite size (I) of (003) plane with space group R-3m.

The crystallite sizes can be calculated from the diffraction angles and the full widths at half maximum of a peak of (110) plane and a peak of (003) plane assigned to a crystal structure with space group R-3m, by means of Scherrer's equation. The peak of (003) plane assigned to a crystal structure with space group R-3m is observed in the vicinity of a diffraction peak 2θ of from 18 to 19° in an X-ray diffraction pattern. The peak of (110) plane assigned to a crystal structure with space group R-3m is observed at a diffraction angle 2θ of from 64 to 66° in an X-ray diffraction pattern.

In an X-ray diffraction pattern of the cathode active material of the present invention, the ratio (I/r) of the crystallite size (I) of (003) plane to the crystallite size (r) of (110) plane assigned to a crystal structure with space group R-3m is at least 2.6. That is, crystallites constituting primary particles of the cathode active material of the present invention have a longitudinal shape with a short size in the a-b axis direction of the crystallite as compared with the size in the c-axis direction of the crystallite. By the crystallites having such a structure, the structure is stabilized after Li is removed from the crystallites at the time of charge, and Li is likely to be inserted into the interior of the crystallites of the cathode active material at the time of discharge, and a cathode active material having such crystallites can improve the cycle durability. I/r is preferably at least 2.8, more preferably at least 3. Further, I/r is preferably at most 8, more preferably at most 6, from the viewpoint of the stability of the crystal structure with space group R-3m. Here, the X-ray diffraction measurement may be carried out by the method disclosed in Examples.

Of the cathode active material of the present invention, the crystallite size (I) of (003) plane assigned to a crystal structure with space group R-3m is preferably from 40 to 200 nm, more preferably from 40 to 100 nm. When the crystallite size (I) is at least the lower limit value, a high discharge capacity of an obtainable battery is likely to be achieved. Further, when the crystallite size (I) is at most the upper limit value, favorable cycle durability of an obtainable battery is likely to be achieved. In this specification, a crystallite means a maximum agglomerate which can be considered as a single crystal.

In the cathode active material of the present invention, the crystallite size (r) of (110) plane assigned to a crystal structure with space group R-3m is preferably from 5 to 80 nm, more preferably from 10 to 40 nm. When the crystallite size (r) is at least the lower limit value, the stability of the crystal structure will improve. When the crystallite size (r) is at most the upper limit value, excellent cycle durability is likely to be obtained.

The lithium-containing composite oxide essentially contains at least one transition metal element selected from the group consisting of Ni, Co and Mn. And, as the case requires, it may contain another metal element. Such another metal element may, for example, be Mg, Ca, Sr, Ba, Al, Ti, Zr, B, Fe, Zn, Y, Nb, Mo, Ta, W, Ce or La. As such another metal, as the case requires, one may be contained, or two or more may be contained.

The lithium-containing composite oxide preferably contains Ni and Mn, whereby a high discharge capacity is likely to be achieved, and more preferably contains Ni, Co and Mn. In the lithium-containing composite oxide, the contents of Ni, Co and Mn are preferably such that the Ni molar proportion (percentage of Ni/M) is from 10 to 50%, the Co molar proportion (percentage of Co/M) is from 0 to 33.3%, and the Mn molar proportion (percentage of Mn/M) is from 33.3 to 85% based on the total amount (M) of metal elements other than Li contained in the lithium-containing composite oxide, whereby a high discharge capacity and excellent cycle durability are likely to be achieved.

In the cathode active material of the present invention, the Ni molar proportion is more preferably from 15 to 50%, particularly preferably from 20 to 50%. When the Ni molar proportion is at least the lower limit value, the discharge voltage of a lithium ion secondary battery using such a cathode active material is high. When the Ni molar proportion is at most the upper limit value, the discharge capacity of a lithium ion secondary battery using such a cathode active material is high.

In the cathode active material of the present invention, the Mn molar proportion is more preferably from 40 to 77%, particularly preferably from 40 to 72%. When the Mn molar proportion is at least the lower limit value, the discharge capacity of a lithium ion secondary battery using such a cathode active material is high. When the Mn molar proportion is at most the upper limit value, I/r is likely to be controlled to be at least 2.6, and the discharge voltage of a lithium ion secondary battery using such a cathode active material is high.

In the cathode active material of the present invention, the Co molar proportion is more preferably from 0 to 30%, particularly preferably from 0 to 28%. When the Co molar proportion is at most the upper limit value, the cycle durability of a lithium ion secondary battery using such a cathode active material is improved.

In the cathode active material of the present invention, the total amount of other metal elements is such that the molar proportion of other metal elements is preferably from 0 to 5%, more preferably from 0 to 3%, particularly preferably from 0 to 2% based on the total amount (M) of the metal elements other than Li contained in the lithium-containing composite oxide. When the total molar proportion of other metal elements is at most the upper limit value, the discharge capacity of a lithium ion secondary battery using such a cathode active material is high.

The amount of Li contained in the lithium-containing composite oxide is an amount which satisfies the molar ratio (Li/M) of the amount of Li to the total amount (M) of the metal elements other than Li contained in the lithium-containing composite oxide of from 1.1 to 1.7. Li/M is preferably from 1.1 to 1.55, more preferably from 1.15 to 1.45. A cathode active material of which Li/M is within such a range can achieve a high discharge capacity of a lithium ion secondary battery.

The cathode active material of the present invention preferably comprises a lithium-containing composite oxide represented by the formula (2), whereby a high discharge capacity and excellent cycle durability are likely to be obtained.

LiₐNi_{α}Co_{β}Mn_{γ}Oₓ (2)

wherein “a” is from 1.1 to 1.7, α is from 0.1 to 0.5, β is from 0 to 0.33, γ is from 0.34 to 0.85, α+β+γ=1, and x is the number of moles of O required to satisfy the valences of Li, Ni, Co and Mn.

In the lithium-containing composite metal compound, “a” is preferably from 1.1 to 1.55, more preferably from 1.15 to 1.45, whereby a high discharge capacity and excellent cycle durability are likely to be obtained.

α is preferably from 0.15 to 0.5, more preferably from 0.2 to 0.5, from the same reason as “a”.

β is preferably from 0 to 0.3, more preferably from 0 to 0.28, from the same reason as “a”.

γ is preferably from 0.4 to 0.77, more preferably from 0.4 to 0.72, from the same reason as “a”.

x is preferably from 2 to 2.7, more preferably from 2.1 to 2.6, from the same reason as “a”.

The cathode active material of the present invention is constituted by primary particles having a plurality of crystallites having the above crystal structure agglomerated, and secondary particles having a plurality of such primary particles agglomerated. Primary particles are, for example, minimum particles observed by a scanning electron microscope (SEM).

The average particle size (D₅₀) of the cathode active material of the present invention is preferably from 3 to 15 μm. When D₅₀ of the cathode active material is within the above range, the discharge capacity of a lithium ion secondary battery is high. D₅₀ of the cathode active material is more preferably from 4 to 15 μm, particularly preferably from 5 to 12 μm.

In this specification, D₅₀ is a particle size at a point of 50% on an accumulative volume distribution curve which is drawn by obtaining the particle size distribution on the volume basis and taking the whole to be 100%. The particle size distribution is obtained from the frequency distribution and an accumulative volume distribution curve measured by means of a laser scattering particle size distribution measuring apparatus. To measure the particle size, the particle size distribution is measured by sufficiently dispersing the powder in an aqueous medium by e.g. ultrasonic treatment. Specifically, measurement may be carried out by the method disclosed in Examples.

D₉₀/D₁₀ of the cathode active material of the present invention is preferably at most 2.4. When D₉₀/D₁₀ is at most 2.4, the particle size distribution is narrow, whereby the electrode density can be made high. A high electrode density is preferred, whereby a battery to obtain the same discharge capacity can be made smaller. D₉₀/D₁₀ is preferably at least 1. D₉₀/D₁₀ of the cathode active material is more preferably at most 2.3, particularly preferably at most 2.2. D₁₀ and D₉₀ are particle sizes at points of 10% and 90%, respectively, on the accumulative volume distribution curve.

The average particle size of primary particles corresponding to a circle of the cathode active material of the present invention is preferably from 10 to 1,000 nm. When the average particle size of primary particles corresponding to a circle is within such a range, at the time of preparing a lithium ion secondary battery, an electrolytic solution is likely to sufficiently permeate through the cathode active material in the positive electrode.

The particle size corresponding to a circle is preferably from 150 to 900 nm, more preferably from 200 to 800 nm. In this specification, the particle size corresponding to a circle is the diameter of a circle having the same surface area as a projection drawing of a particle assuming that the projection drawing of the particle is a circle. Measurement is carried out in the same manner with respect to other primary particles, and the average of totally 100 measured values is taken as the average particle size corresponding to a circle. As a projection drawing of a particle, an image observed with a SEM with such a magnification that 100 to 150 primary particles are contained in one SEM image, is used. To measure the particle size corresponding to a circle, for example, an image analysis particle size distribution software (manufactured by Mountech Co., Ltd., tradename: Mac-View) may be used.

The specific surface area of the cathode active material of the present invention is preferably from 0.1 to 10 m²/g. When the specific surface area is at least the lower limit value, a high discharge capacity is likely to be obtained. When the specific surface area of the cathode active material is at most the upper limit value, excellent cycle durability tends to be obtained. The specific surface area of the cathode active material is more preferably from 0.5 to 7 m²/g, particularly preferably from 0.5 to 5 m²/g. The specific surface area of the cathode active material may be measured by the method disclosed in Examples.

### (Production Method)

As a method for producing the cathode active material of the present invention, a method of mixing a coprecipitate obtained by coprecipitation method with a lithium compound and firing the mixture, is preferred, whereby a high discharge capacity is likely to be obtained. The coprecipitation method is preferably alkali coprecipitation method or carbonate coprecipitation method, and is particularly preferably alkali coprecipitation method, whereby excellent cycle durability is likely to be obtained.

The alkali coprecipitation method is a method of continuously adding an aqueous metal salt solution containing the transition metal element and a pH adjusting liquid containing a strong alkali to a reaction container and mixing them to precipitate a hydroxide containing the transition metal element in the reaction solution while the pH of the reaction solution is kept constant. By the alkali coprecipitation method, the powder density of the obtainable coprecipitate is high, and a cathode active material having an excellent packing density in a cathode active material layer will be obtained.

The metal salt containing the transition metal element may be a nitrate, acetate, chloride salt or sulfate of the transition metal element. Preferred is a sulfate of the transition metal element, whereby excellent battery characteristics will be obtained at a relatively low material cost, and is more preferably at least one sulfate selected from the group consisting of a sulfate of Ni, a sulfate of Co and a sulfate of Mn.

The sulfate of Ni may, for example, be nickel(II) sulfate hexahydrate, nickel(II) sulfate heptahydrate or nickel(II) ammonium sulfate hexahydrate.

The sulfate of Co may, for example, be cobalt(II) sulfate heptahydrate or cobalt(II) ammonium sulfate hexahydrate.

The sulfate of Mn may, for example, be manganese(II) sulfate pentahydrate or manganese(II) ammonium sulfate hexahydrate.

The pH of the solution during the reaction in the alkali coprecipitation method is preferably from 10 to 12.

The pH adjusting liquid containing a strong alkali to be added is preferably an aqueous solution containing at least one member selected from the group consisting of sodium hydroxide, potassium hydroxide and lithium hydroxide. Among them, an aqueous sodium hydroxide solution is more preferred.

To the reaction solution in the alkali coprecipitation method, an aqueous ammonia solution or an aqueous ammonium sulfate solution may be added to adjust the solubility of the transition metal element.

The carbonate coprecipitation method is a method of continuously adding an aqueous metal salt solution containing the transition metal element and an aqueous carbonate solution of an alkali metal to a reaction container and mixing the solutions to precipitate a carbonate containing the transition metal element in the reaction solution. By the carbonate coprecipitation method, the coprecipitate to be obtained is porous and has a large specific surface area, and a cathode active material exhibiting a high discharge capacity will be obtained.

The metal salt containing the transition metal element to be used in the carbonate coprecipitation method may be the same transition metal salt as mentioned for the alkali coprecipitation method.

The pH of the solution during the reaction in the carbonate coprecipitation method is preferably from 7 to 9.

The aqueous carbonate solution of an alkali metal is preferably an aqueous solution containing at least one member selected from the group consisting of sodium carbonate, sodium hydrogen carbonate, potassium carbonate and potassium hydrogen carbonate.

To the reaction solution in the carbonate coprecipitation method, an aqueous ammonia solution or an aqueous ammonium sulfate solution may be added from the same reason as the alkali coprecipitation method.

By controlling the conditions of the coprecipitation method, I/r of the cathode active material can be adjusted to be within a desired range. With respect to the content of the metal element, in addition to the above-described conditions, the lower the Mn proportion is, the higher I/r tends to be. In the reaction for precipitation of a coprecipitate, the lower the reaction temperature is, or the longer the reaction time is, the higher I/r tends to be. Further, I/r tends to be high when the reaction for precipitation of a coprecipitate is carried out in a nitrogen atmosphere.

The reaction solution containing a coprecipitate precipitated by the coprecipitation method is preferably subjected to a step of removing the aqueous solution by filtration or centrifugal separation. For filtration or centrifugal separation, a pressure filter, a vacuum filter, a centrifugal classifier, a filter press, a screw press or a rotary dehydrator may, for example, be used.

The obtained coprecipitate is preferably subjected to a washing step to remove impurity ions such as free alkali. As a method of washing the coprecipitate, for example, a method of repeating pressure filtration and dispersion in distilled water may be mentioned. In a case where washing is carried out, washing is preferably repeated until the electrical conductivity of a supernatant liquid when the coprecipitate is dispersed in distilled water becomes at most 50 mS/m, more preferably at most 20 mS/m.

The particle size D₅₀ of the coprecipitate is preferably from 3 to 15 μm. When D₅₀ of the coprecipitate is within the above range, D₅₀ of the cathode active material can be from 3 to 15 μm, and a high discharge capacity tends to be obtained. D₅₀ of the coprecipitate is more preferably from 4 to 15 μm, particularly preferably from 5 to 12 μm.

The ratio (D₉₀/D₁₀) of the particle size D₉₀ to the particle size D₁₀ of the coprecipitate is preferably at most 2.5. When D₉₀/D₁₀ of the coprecipitate is at most 2.5, a cathode active material which achieves excellent cycle durability tends to be obtained. D₉₀/D₁₀ of the coprecipitate is preferably at least 1. D₉₀/D₁₀ of the coprecipitate is more preferably at most 2.3, particularly preferably at most 2.1.

The specific surface area of the coprecipitate is preferably from 10 to 300 m²/g. The specific surface area of the coprecipitate is more preferably from 10 to 150 m²/g, particularly preferably from 10 to 50 m²/g. The specific surface area of the coprecipitate is the specific surface area after the coprecipitate is heated at 120° C. for 15 hours. The specific surface area of the coprecipitate reflects the pore structure formed by the precipitation reaction, and when it is within the above range, the specific surface area of the cathode active material is easily controlled, and favorable battery characteristics tend to be obtained.

The lithium compound is not particularly limited so long as a lithium-containing composite oxide is obtained by mixing it with the coprecipitate and firing the mixture. Such a lithium compound is preferably lithium carbonate, lithium hydroxide or lithium nitrate, more preferably lithium carbonate, which is available at a low cost.

As a method of mixing the coprecipitate and the lithium compound, for example, a method of using a rocking mixer, a nauta mixer, a spiral mixer, a cutter mill or a V mixer may be mentioned.

The firing temperature is preferably from 500 to 1,000° C. When the firing temperature is within the above range, a cathode active material having high crystallinity tends to be obtained. The firing temperature is more preferably from 600 to 1,000° C., particularly preferably from 800 to 950° C.

The firing time is preferably from 4 to 40 hours, more preferably from 4 to 20 hours.

Firing may be carried out by one-step firing at from 500 to 1,000° C., or may be carried out by two-step firing comprising temporary firing at from 400 to 700° C. and then main firing at from 700 to 1,000° C. Two-step firing is preferred, whereby Li tends to be uniformly dispersed in the cathode active material.

In the case of the two-step firing, the temperature for temporary firing is preferably from 400 to 700° C., more preferably from 500 to 650° C. Further, in the case of the two-step firing, the temperature for main firing is preferably from 700 to 1,000° C., more preferably from 800 to 950° C.

The firing apparatus may, for example, be an electric furnace, a continuous firing furnace or a rotary kiln.

In a case where firing is carried out by the one-step firing, the firing atmosphere is preferably air atmosphere, and firing is carried out particularly preferably while the air is supplied, whereby the coprecipitate is oxidized during firing.

In a case where firing is carried out by the two-step firing, the firing atmosphere in at least one of temporary firing and main firing is air atmosphere. As the atmosphere in the two-step firing, temporary firing may be carried out in the air atmosphere and main firing is carried out in a low-oxygen atmosphere, temporary firing and main firing may be carried out in the air atmosphere, or the like. The low-oxygen atmosphere is preferably an atmosphere having an oxygen volume ratio of at most 0.1%, more preferably an atmosphere having a nitrogen volume ratio of at least 99.9%.

The rate of supply of the air is preferably from 10 to 200 mL/min, more preferably from 40 to 150 mL/min per 1 L of the internal capacity of the furnace.

By supplying the air during firing, the metal element (X) in the coprecipitate is sufficiently oxidized, whereby a cathode active material having high crystallinity and having a desired crystal phase will be obtained.

The method for producing the cathode active material of the present invention is not limited to the above method, and a hydrothermal synthesis method, a sol gel method, a dry mixing method (solid phase method), an ion exchange method or a glass crystallization method may, for example, be employed.

### [Positive Electrode for Lithium Ion Secondary Battery]

The cathode active material of the present invention is suitably used for a positive electrode for a lithium ion secondary battery.

The positive electrode for a lithium ion secondary battery comprises a cathode current collector and a cathode active material layer formed on the cathode current collector. For the positive electrode for a lithium ion secondary battery, a known embodiment may be employed except that the cathode active material obtained by the production method of the present invention is employed.

### (Cathode Current Collector)

The cathode current collector may, for example, be an aluminum foil or a stainless steel foil.

### (Cathode Active Material Layer)

The cathode active material layer is a layer containing the cathode active material of the present invention, an electrically conductive material and a binder. The cathode active material layer may contain another component such as a thickener as the case requires.

The electrically conductive material may, for example, be acetylene black, graphite or carbon black. As the electrically conductive material, one type may be used, or two or more types may be used in combination.

The binder may, for example, be a fluorinated resin (such as polyvinylidene fluoride or polytetrafluoroethylene), a polyolefin (such as polyethylene or polypropylene), a polymer or copolymer having unsaturated bonds (such as a styrene/butadiene rubber, an isoprene rubber or a butadiene rubber), or an acrylate polymer or copolymer (such as an acrylate copolymer or a methacrylate copolymer). As the binder, one type may be used or two or more types may be used in combination.

As the cathode active material, one type may be used or two or more types may be used in combination.

The thickener may, for example, be carboxymethyl cellulose, methyl cellulose, hydroxymethyl cellulose, ethyl cellulose, polyvinyl alcohol, oxidized starch, phosphorylated starch, casein or polyvinylpyrrolidone. As the thickener, one type may be used or two or more types may be used in combination.

### (Method for Producing Positive Electrode for Lithium Ion Secondary Battery)

As a method for producing the positive electrode for a lithium ion secondary battery, a known production method may be employed except that the cathode active material of the present invention is used. For example, as a method for producing the positive electrode for a lithium ion secondary battery, the following method may be mentioned.

The cathode active material, the electrically conductive material and the binder are dissolved or dispersed in a medium to obtain a slurry, or the cathode active material, the electrically conductive material and the binder are kneaded with a medium to obtain a kneaded product. Then, the obtained slurry or kneaded product is applied to the cathode current collector to form the cathode active material layer.

### [Lithium Ion Secondary Battery]

A lithium ion secondary battery has the positive electrode for a lithium ion secondary batter, a negative electrode and a non-aqueous electrolyte.

### [Negative Electrode]

The negative electrode contains at least an anode current collector and an anode active material layer.

As a material of the anode current collector, nickel, copper or stainless steel may, for example, be mentioned.

The anode active material layer at least contains an anode active material and as the case requires, contains a binder.

The anode active material may be any material so long as it is capable of absorbing and desorbing lithium ions. It may, for example, be a lithium metal, a lithium alloy, a lithium compound, a carbon material, a silicon carbide compound, a silicon oxide compound, titanium sulfide, a boron carbide compound or an alloy composed mainly of silicon, tin or cobalt.

The carbon material to be used for the anode active material may, for example, be non-graphitized carbon, artificial graphite, natural graphite, thermally decomposed carbon, cokes, graphites, glassy carbons, an organic polymer compound fired product, carbon fibers, activated carbon or carbon blacks. The cokes may, for example, be pitch coke, needle coke or petroleum coke. The organic polymer compound fired product may be a product obtained by firing and carbonizing a phenol resin, a furan resin or the like at an appropriate temperature.

In addition, as the material capable of absorbing and desorbing lithium ions, for example, iron oxide, ruthenium oxide, molybdenum oxide, tungsten oxide, titanium oxide, tin oxide or Li_{2.6}Co_{0.4}N may also be used as the anode active material.

The binder may be the same as the binder mentioned for the cathode active material layer.

The anode may be obtained, for example, by mixing the anode active material with an organic solvent to prepare a slurry, and applying the prepared slurry to an anode current collector, followed by drying and pressing.

The non-aqueous electrolyte may, for example, be a non-aqueous electrolytic solution, an inorganic solid electrolyte, or a solid or gelled polymer electrolyte in which an electrolyte salt is mixed with or dissolved in e.g. a polymer compound.

The non-aqueous electrolytic solution may be one prepared by properly combining an organic solvent and an electrolyte salt.

The organic solvent contained in the non-aqueous electrolytic solution may, for example, be a cyclic carbonate, a chain carbonate, 1,2-dimethoxyethane, 1,2-diethoxyethane, diglyme, triglyme, γ-butyrolactone, diethyl ether, sulfolane, methyl sulfolane, acetonitrile, an acetic acid ester, a butyric acid ester or a propionic acid ester. The cyclic carbonate may, for example, be propylene carbonate or ethylene carbonate. The chain carbonate may, for example, be diethyl carbonate or dimethyl carbonate. Among them, in view of the voltage stability, preferred is the cyclic carbonate or the chain carbonate, more preferred is propylene carbonate, dimethyl carbonate or diethyl carbonate. They may be used alone or in combination of two or more.

The polymer compound to be used for the solid polymer electrolyte in which an electrolyte salt is mixed with or dissolved in the polymer compound, may, for example, be polyethylene oxide, polypropylene oxide, polyphosphazene, polyaziridine, polyethylene sulfide, polyvinyl alcohol, polyvinylidene fluoride, polyhexafluoropropylene or a derivative, mixer or composite thereof.

The polymer compound to be used for the gelled polymer electrolyte in which an electrolyte salt is mixed with or dissolved in the polymer compound may, for example, be a fluorinated polymer compound, polyacrylonitrile, a copolymer of polyacrylonitrile, polyethylene oxide or a copolymer of polyethylene oxide. The fluorinated polymer compound may, for example, be poly(vinylidene fluoride) or poly(vinylidene fluoride-co-hexafluoropropylene).

As a matrix of the gelled electrolyte, preferred is a fluorinated polymer compound from the viewpoint of the stability in the oxidation/reduction reaction.

The electrolyte salt may, for example, be LiClO₄, LiPF₆, LiBF₄, CF₃SO₃Li, LiCl or LiBr.

The inorganic solid electrolyte may, for example, be lithium nitride or lithium iodide.

The shape of the lithium ion secondary battery is not particularly limited and may, for example, be a coin-shape, a sheet-form (film-form), a folded shape, a wound cylinder with bottom, or a button shape, and is suitably selected depending upon the intended use.

### EXAMPLES

Now, the present invention will be described in further detail with reference to Examples. However, it should be understood that the present invention is by no means restricted thereto. Ex. 1 to 15 are Examples of the present invention, and Ex. 16 to 20 are Comparative Examples.

### [Specific Surface Area]

The specific surface area the cathode active material was calculated by a nitrogen adsorption BET (Brunauer, Emmett, Teller) method using a specific surface area measuring apparatus (apparatus name: HM model-1208) manufactured by Mountech Co., Ltd. Deaeration was carried out at 200° C. for 20 minutes.

### [Particle Size]

The cathode active material was sufficiently dispersed in water by ultrasonic treatment, and measurement by a laser diffraction/scattering type particle size distribution measuring apparatus (apparatus name: MT-3300EX) manufactured by NIKKISO CO., LTD., was carried out and the frequency distribution and an accumulative volume distribution curve were obtained, whereby the volume-based particle size distribution was obtained. The particle sizes at points of 10%, 50% and 90% on the obtained accumulative volume distribution curve were taken as D₁₀, D₅₀ and D₉₀, respectively.

### [Crystallite Size]

The X-ray diffraction of the cathode active material was measured by an X-ray diffraction apparatus manufactured by Rigaku Corporation (apparatus name: SmartLab). The measurement conditions are shown in Table 1. The measurement was carried out at 25° C. With respect to the obtained X-ray diffraction pattern, peak search was carried out using integrated X-ray powder diffraction software PDXL2 manufactured by Rigaku Corporation, and the crystallite sizes (I) and (r) were calculated from the diffraction angles and the full widths at half maximum of a peak of (003) plane and a peak of (110) plane assigned to a crystal structure with space group R-3m, by means of Scherrer's equation. Further, the ratio (I/r) of the crystallite size (I) to the crystallite size (r) was calculated. Further, the peak intensity ratio of a peak of (020) plane assigned to a crystal structure with space group C2/m to a peak of (003) plane assigned to a crystal structure with space group R-3m was calculated.

As the above peaks, a peak of (003) plane assigned to a crystal structure with space group R-3m observed in the vicinity of a diffraction angle 2θ of 18 to 19° in an X-ray diffraction pattern, a peak of (110) plane assigned to a crystal structure with space group R-3m observed in the vicinity of a diffraction angle 2θ of 64°, and a peak of (020) plane assigned to a crystal structure with space group C2/m observed in the vicinity of a diffraction angle 2θ of 21 to 22°, were employed.

TABLE 1

| | | |
|---|---|---|
| Apparatus | Measurement apparatus | SmartLab manufactured by Rigaku |
| condition | | Corporation |
| | Target | Cu |
| | Detector | D/teX Ultra HE manufactured by Rigaku |
| | | Corporation |
| | Detector baseline | 44div |
| | Detector window | 8 div |
| | Gonio length | 300 mm |
| | Soller/PSC | 5.0 (deg.) |
| | IS long dimension | 10 (mm) |
| | PSA | Open |
| | Soller | 5.0 (deg.) |
| | Monochromatization | Kβ filter method |
| | method | |
| Sample | Sample holder | Diameter: 24 mm, depth: 0.5 mm |
| condition | Rotation of sample during | Rotated (30 rpm) |
| | measurement | |
| Measurement | Measurement method | General purpose measurement (focal |
| condition | | method) |
| | Scanning axis | 2θ/θ |
| | Mode | Continuous |
| | Range specification | Absolute |
| | Initiation (deg.) | 10 (deg.) |
| | Termination (deg.) | 90 (deg.) |
| | Step (deg.) | 0.01 (deg.) |
| | Speed measurement time | 10 (deg./min.) |
| | IS (deg.) | 1/3 (deg.) |
| | RS1 (mm) | 8 (mm) |
| | RS2 (mm) | 13 (mm) |
| | Attenuator | Open |
| | Tube voltage (kV) | 45 (kV) |
| | Tube current (mA) | 200 (mA) |
| Data | Analysis software | PDXL2 manufactured by Rigaku |
| processing | | Corporation |
| condition | Smoothing | Smoothing by B-Spline, X threshold: 1.50 |
| | Background removal | Fitting |
| | Kα2 removal | Intensity ratio: 0.4970 |
| | Peak search | Secondary differentiation σ cut: 3.00 |
| | Profile fitting | Fitting of measurement data |
| | Peak shape | Variance pseudo-voigt function |

### [Composition Analysis]

The composition of the cathode active material was analyzed by a plasma emission spectrometer (manufactured by SII NanoTechnology Inc., model:SPS3100H). From the obtained composition, a, α, β and γ in the formula (2) were calculated. x is the number of moles required to satisfy the valences of Li, Ni, Co and Mn.

### [Evaluation Method]

### (Production of Cathode Sheet)

The cathode active material obtained in each Example, acetylene black as the electrically conductive material, and polyvinylidene fluoride (binder) were weighed in a mass ratio of 80:10:10 and added to N-methylpyrrolidone to prepare a slurry.

Then, the slurry was applied on one side of an aluminum foil (cathode current collector) having a thickness of 20 μm by means of a doctor blade. The gap of the doctor blade was adjusted so that the thickness of the cathode sheet after roll pressing would be 30 μm. After drying at 120° C., roll pressing was carried out twice to prepare a cathode sheet.

### (Production of Lithium Ion Secondary Battery)

Using as a positive electrode a circle having a diameter of 18 mm punched out from the obtained cathode sheet, a stainless steel simple sealed cell type lithium ion secondary battery was assembled in an argon glove box. As a negative electrode, a metal lithium foil having a thickness of 500 μm was formed on a stainless steel plate having a thickness of 1 mm as an anode current collector. As a separator, a porous polypropylene having a thickness of 25 μm was used. Further, as an electrolytic solution, a solution of LIPF₆ at a concentration of 1 mol/dm³ in a mixed solution of ethylene carbonate (EC) and diethyl carbonate (DEC) in a volume ratio of 1:1 was used.

### (Initial Discharge Capacity and Capacity Retention)

The lithium ion secondary battery was charged to 4.6 V with a load current of 20 mA per 1 g of the cathode active material at a constant current at a constant voltage of 4.6 V over a period of 23 hours and then discharged to 2.0 V with a load current of 20 mA per 1 g of the cathode active material. The discharge capacity at this time was taken as the initial discharge capacity.

Then, the lithium ion secondary battery was charged to 4.5 V with a load current of 200 mA per 1 g of the cathode active material and then discharged to 2.0 V with a load current of 200 mA per 1 g of the cathode active material, and this charge and discharge cycle was repeated 100 times. The ratio of the discharge capacity in 100th 4.5 V charge based on the discharge capacity in the third 4.5 V charge was taken as the capacity retention (%).

### Ex. 1

Nickel(II) sulfate hexahydrate, cobalt(II) sulfate heptahydrate and manganese(II) sulfate pentahydrate were dissolved in distilled water so that the proportion of Ni, Co and Mn would be as shown in Table 2 and that the total concentration of Ni, Co and Mn would be 1.5 mol/L to obtain an aqueous sulfate solution. Ammonium sulfate was dissolved in distilled water to prepare a 0.75 mol/L aqueous ammonium sulfate solution.

Into a 2 L baffle-equipped glass reactor, distilled water was put and heated to 50° C. by a mantle heater, and the aqueous sulfate solution and the aqueous ammonium sulfate solution were added while the solution in the reactor was stirred by a two-stage tilt paddle type stirring blade. The rate of addition of the aqueous sulfate solution was 5.0 g/min. The aqueous ammonium sulfate solution was added over a period of 28 hours so that the molar ratio (NH₄⁺/M) of ammonium ions based on the total amount of the metal elements (M) of Ni, Co and Mn would be as shown in Table 2. Further, a 48 mass % aqueous sodium hydroxide solution was added to keep the pH of the reaction solution of 11.0, to precipitate a coprecipitate containing Ni, Co and Mn (a composite hydroxide). The initial pH of the reaction solution was 7.0. During the precipitation reaction, a nitrogen gas was made to flow through the reactor at a rate of 2 L/min so that the precipitated coprecipitate would not be oxidized.

The obtained coprecipitate was washed by repetition of pressure filtration and dispersion in distilled water to remove impurity ions. Washing was completed at a point where the electrical conductivity of the filtrate became less than 20 mS/m. The coprecipitate after washing was dried at 120° C. for 15 hours.

Then, the obtained coprecipitate and lithium carbonate were mixed so that the molar ratio (Li/M) of Li based on the total amount of the metal elements (M) of Ni, Co and Mn would be as shown in Table 2, and the mixture was subjected to temporary firing in the air atmosphere at 600° C. for 5 hours and then main firing at 850° C. for 16 hours to obtain a cathode active material comprising a composite oxide.

### Ex. 2 to 6

A cathode active material was obtained in the same manner as in Ex. 1 except that the charge proportion of the sulfates, the reaction time (the time of addition of the aqueous sulfate solution), the pH of the reaction solution, the reaction temperature and the NH₄⁺/M and Li/M ratios were changed as identified in Table 2.

### Ex. 7 to 15

A cathode active material was obtained in the same manner as in Ex. 1 except that the charge proportion of the sulfates, the reaction time (the time of addition of the aqueous sulfate solution), the pH of the reaction solution, the reaction temperature and the NH₄⁺/M and Li/M ratios were changed as identified in Table 2, and that the atmosphere in main firing was a low-oxygen atmosphere. The low-oxygen atmosphere in Ex. 7 to 15 was an atmosphere having an oxygen volume ratio of at most 0.01% and a nitrogen volume ratio of 99.99%. The low-oxygen atmosphere is represented as “nitrogen” in Table 2.

### Ex. 16 and 17

A cathode active material was obtained in the same manner as in Ex. 1 except that the charge proportion of the sulfates, the reaction time (the time of addition of the aqueous sulfate solution), the pH of the reaction solution, the reaction temperature and the NH₄⁺/M and Li/M ratios were changed as identified in Table 2.

### Ex. 18

Nickel(II) sulfate hexahydrate, cobalt(II) sulfate heptahydrate and manganese(II) sulfate pentahydrate were dissolved in distilled water so that the proportion of Ni, Co and Mn would be as shown in Table 2 and that the total concentration of Ni, Co and Mn would be 1.5 mol/L to obtain an aqueous sulfate solution. Sodium carbonate was dissolved in distilled water to prepare a 1.5 mol/L aqueous carbonate solution.

Into a 2 L baffle-equipped glass reactor, distilled water was put and heated to 30° C. by a mantle heater, and the aqueous sulfate solution was added at a rate of 5.0 g/min over a period of 14 hours while the solution in the reactor was stirred by a two-stage tilt paddle type stirring blade, and the aqueous carbonate solution was added to keep the pH of the reaction solution of 8.0, to precipitate a coprecipitate containing Ni, Co and Mn (a composite carbonate).

The obtained coprecipitate was washed by repetition of pressure filtration and dispersion in distilled water to remove impurity ions. Washing was completed at a point where the electrical conductivity of the filtrate became less than 20 mS/m. The coprecipitate after washing was dried at 120° C. for 15 hours.

Then, the obtained coprecipitate and lithium carbonate were mixed so that Li/M would be as shown in Table 2, and the mixture was subjected to temporary firing in the air atmosphere at 600° C. for 5 hours and then main firing at 870° C. for 16 hours to obtain a cathode active material comprising a composite oxide.

### Ex. 19 and 20

A cathode active material was obtained in the same manner as in Ex. 18 except that the charge proportion of the sulfates, the reaction time (the time of addition of the aqueous sulfate solution), the pH of the reaction solution, the reaction temperature and the NH₄⁺/M and Li/M ratios and the filing temperature were changed as identified in Table 2.

The values of a, α, β, γ and x when the obtained cathode active material obtained in each Ex. was represented by the formula (2) (LiₐNi_{α}Co_{β}Mn_{γ}Oₓ), I/r, the particle size and the specific surface area are shown in Table 3.

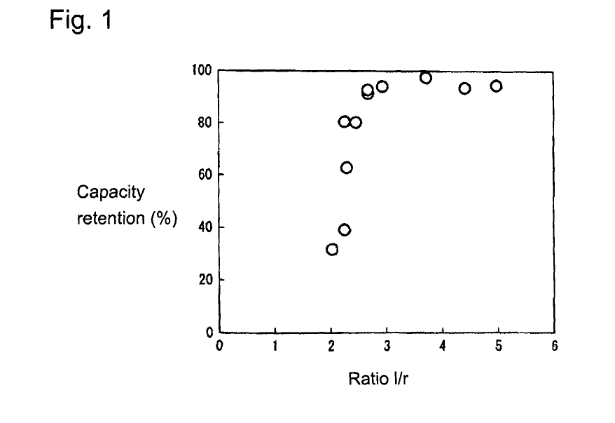

Further, the results of measurement of the initial discharge capacity and the capacity retention of the lithium ion secondary battery using the cathode active material in each Ex. are shown in Table 4. Further, the relation between I/r and the capacity retention is shown in FIG. 1.

TABLE 2

| | Precipitation reaction conditions | | | | | | | | | | | | | |
|---|---|---|---|---|---|---|---|---|---|---|---|---|---|---|
| | Charge molar | | | | | | | | | | | | | |
| | proportion of | | | | Reac- | | | | | Lithiation conditions | | | | |
| | sulfates | | | | tion | | | Reaction | | | Temporary firing | | Main firing | |
| | Ni | Co | Mn | | time | Initial | Controlled | temperature | NH₄/M | Charge | Temperature | Atmos- | Temperature | Atmos- |
| No. | [%] | [%] | [%] | Alkali | [hr.] | pH | pH | [° C.] | ratio | Li/M | [° C.] | phere | [° C.] | phere |
| 1 | 38.57 | 8.57 | 52.86 | NaOH | 28 | 7 | 11 | 50 | 0.10 | 1.172 | 600 | Air | 850 | Air |
| 2 | 34.62 | 0.00 | 65.38 | NaOH | 14 | 7 | 11 | 50 | 0.10 | 1.343 | 600 | Air | 850 | Air |
| 3 | 42.86 | 0.00 | 57.14 | NaOH | 14 | 7 | 11 | 50 | 0.10 | 1.179 | 600 | Air | 850 | Air |
| 4 | 38.57 | 8.57 | 52.86 | NaOH | 14 | 7 | 11 | 50 | 0.10 | 1.174 | 600 | Air | 850 | Air |
| 5 | 38.57 | 8.57 | 52.86 | NaOH | 14 | 7 | 11 | 50 | 0.50 | 1.180 | Nil | Nil | 850 | Air |
| 6 | 38.57 | 8.57 | 52.86 | NaOH | 14 | 7 | 11 | 30 | 0.10 | 1.180 | Nil | Nil | 850 | Air |
| 7 | 38.57 | 8.57 | 52.86 | NaOH | 14 | 11 | 10 | 50 | 0.10 | 1.180 | 600 | Air | 850 | Nitrogen |
| 8 | 38.57 | 8.57 | 52.86 | NaOH | 14 | 7 | 11 | 50 | 0.50 | 1.180 | 600 | Air | 850 | Nitrogen |
| 9 | 38.57 | 8.57 | 52.86 | NaOH | 14 | 11 | 11 | 50 | 0.10 | 1.180 | 600 | Air | 850 | Nitrogen |
| 10 | 34.62 | 0.00 | 65.38 | NaOH | 14 | 7 | 11 | 50 | 0.10 | 1.343 | 600 | Air | 850 | Nitrogen |
| 11 | 25.00 | 0.00 | 75.00 | NaOH | 14 | 7 | 11 | 50 | 0.10 | 1.536 | 600 | Air | 850 | Nitrogen |
| 12 | 32.31 | 4.62 | 63.08 | NaOH | 14 | 7 | 11 | 50 | 0.10 | 1.342 | 600 | Air | 750 | Nitrogen |
| 13 | 38.57 | 8.57 | 52.86 | NaOH | N.D. | N.D. | N.D. | N.D. | N.D. | 1.180 | 600 | Air | 850 | Nitrogen |
| 14 | 38.57 | 8.57 | 52.86 | NaOH | N.D. | N.D. | N.D. | N.D. | N.D. | 1.180 | 600 | Air | 800 | Nitrogen |
| 15 | 38.57 | 8.57 | 52.86 | Na₂CO₃ | N.D. | N.D. | N.D. | N.D. | N.D. | 1.145 | 600 | Air | 850 | Nitrogen |
| 16 | 38.57 | 8.57 | 52.86 | Na₂CO₃ | 14 | 10 | 8 | 30 | 0.00 | 1.145 | 600 | Air | 870 | Air |
| 17 | 38.57 | 8.57 | 52.86 | Na₂CO₃ | 28 | 10 | 8 | 30 | 0.00 | 1.145 | 600 | Air | 870 | Air |
| 18 | 38.57 | 8.57 | 52.86 | Na₂CO₃ | 28 | 10 | 8.5 | 60 | 0.00 | 1.125 | 600 | Air | 850 | Air |
| 19 | 13.64 | 0.00 | 86.36 | NaOH | 14 | 7 | 11 | 50 | 0.10 | 1.763 | 600 | Air | 850 | Air |
| 20 | 38.57 | 8.57 | 52.86 | NaOH | 14 | 7 | 11 | 50 | 0.10 | 1.220 | 600 | Air | 850 | Air |

TABLE 3

| | Cathode active material | | | | | | | | | | | | |
|---|---|---|---|---|---|---|---|---|---|---|---|---|---|
| | | | | Specific | | | | | | | | | Peak |
| | Particle size | | | surface | | | | | | | | | intensity |
| | D₁₀ | D₅₀ | D₉₀ | area | Analytical composition | | | | | Crystallite size | | | ratio |
| No. | [μm] | [μm] | [μm] | [m²/g] | a | α | β | γ | x | l [nm] | r [nm] | l/r | (020)/(003) |
| 1 | 4.1 | 5.9 | 9.0 | 2.1 | 1.17 | 0.39 | 0.08 | 0.53 | 2.17 | 56.5 | 15.1 | 3.73 | 0.02 |
| 2 | 2.9 | 3.8 | 5.4 | 3.8 | 1.34 | 0.35 | 0.00 | 0.65 | 2.34 | 44.5 | 16.6 | 2.68 | 0.10 |
| 3 | 2.9 | 4.2 | 6.4 | 5.0 | 1.18 | 0.43 | 0.00 | 0.57 | 2.18 | 46.2 | 10.5 | 4.42 | 0.09 |
| 4 | 3.0 | 4.4 | 6.9 | 4.0 | 1.17 | 0.39 | 0.08 | 0.53 | 2.17 | 54.1 | 20.2 | 2.68 | 0.04 |
| 5 | 3.5 | 5.1 | 7.6 | 1.9 | 1.18 | 0.39 | 0.08 | 0.53 | 2.18 | 53.9 | 10.8 | 4.99 | 0.06 |
| 6 | 3.9 | 5.9 | 9.3 | 3.4 | 1.18 | 0.39 | 0.08 | 0.53 | 2.18 | 49.4 | 16.8 | 2.94 | 0.02 |
| 7 | 6.3 | 8.5 | 12.1 | 2.6 | 1.18 | 0.39 | 0.08 | 0.53 | 2.18 | 47.3 | 9.9 | 4.77 | 0.02 |
| 8 | 3.3 | 4.5 | 6.6 | 1.0 | 1.18 | 0.39 | 0.08 | 0.53 | 2.18 | 64.7 | 13.5 | 4.80 | 0.08 |
| 9 | 3.9 | 5.1 | 7.2 | 0.9 | 1.18 | 0.39 | 0.08 | 0.53 | 2.18 | 60.3 | 14.7 | 4.11 | 0.09 |
| 10 | 2.7 | 3.6 | 5.1 | 1.1 | 1.34 | 0.35 | 0.00 | 0.65 | 2.34 | 68.4 | 22.3 | 3.06 | 0.05 |
| 11 | 3.2 | 4.3 | 6.1 | 1.5 | 1.54 | 0.25 | 0.00 | 0.75 | 2.54 | 92.8 | 28.3 | 3.28 | 0.09 |
| 12 | 3.9 | 5.4 | 7.7 | 1.1 | 1.34 | 0.32 | 0.05 | 0.63 | 2.34 | 56.9 | 16.2 | 3.51 | 0.08 |
| 13 | 2.9 | 4.4 | 7.1 | 1.5 | 1.18 | 0.39 | 0.08 | 0.53 | 2.18 | 55.6 | 17.3 | 3.21 | 0.04 |
| 14 | 2.6 | 3.7 | 5.7 | 2.3 | 1.18 | 0.39 | 0.08 | 0.53 | 2.18 | 63.4 | 20.6 | 3.08 | 0.12 |
| 15 | 7.4 | 11.4 | 18.8 | 0.9 | 1.15 | 0.39 | 0.08 | 0.53 | 2.15 | 63.6 | 13.4 | 4.76 | 0.03 |
| 16 | 5.9 | 9.6 | 14.9 | 6.0 | 1.15 | 0.38 | 0.09 | 0.53 | 2.15 | 45.8 | 20.0 | 2.29 | 0.07 |
| 17 | 6.1 | 9.5 | 14.5 | 4.8 | 1.15 | 0.38 | 0.09 | 0.53 | 2.15 | 46.7 | 19.0 | 2.46 | 0.04 |
| 18 | 8.5 | 12.4 | 18.9 | 7.2 | 1.13 | 0.39 | 0.08 | 0.53 | 2.13 | 40.9 | 18.1 | 2.26 | 0.03 |
| 19 | 4.1 | 6.1 | 9.7 | 5.5 | 1.76 | 0.14 | 0.00 | 0.86 | 2.76 | 45.8 | 22.7 | 2.02 | 0.29 |
| 20 | 3.8 | 5.3 | 7.8 | 8.0 | 1.22 | 0.38 | 0.09 | 0.53 | 2.22 | 48.7 | 21.7 | 2.24 | 0.03 |

TABLE 4

| | | Capacity |
|---|---|---|
| | Initial discharge | Retention in |
| | capacity | 100th cycle |
| No. | [mAh/g] | [%] |
| 1 | 218.7 | 97.3% |
| 2 | 261.5 | 92.7% |
| 3 | 232.2 | 93.3% |
| 4 | 227.7 | 91.4% |
| 5 | 213.1 | 94.1% |
| 6 | 221.0 | 94.0% |
| 7 | 215.9 | 93.6% |
| 8 | 214.3 | 96.6% |
| 9 | 203.1 | 95.5% |
| 10 | 199.7 | 101.2% |
| 11 | 247.9 | 94.2% |
| 12 | 240.3 | 94.1% |
| 13 | 220.9 | 95.4% |
| 14 | 225.7 | 94.3% |
| 15 | 188.8 | 83.0% |
| 16 | 226.3 | 62.6% |
| 17 | 228.0 | 80.2% |
| 18 | 225.1 | 80.3% |
| 19 | 176.9 | 31.3% |
| 20 | 226.4 | 38.7% |

As shown in Tables 3 and 4, in Ex. 1 to 15, the initial discharge capacity is high since a cathode active material having I/r of at least 2.6, and having a ratio (I₀₂₀/I₀₀₃) of the integrated intensity (I₀₂₀) of a peak of (020) plane assigned to a crystal structure with space group C2/m to the integrated intensity (I₀₀₃) of a peak of (003) plane assigned to a crystal structure with space group R-3m, of from 0.02 to 0.3, is used.

Further, in Ex. 1 to 15, as shown in Table 4 and FIG. 1, the capacity retention is high and excellent cycle durability is achieved as compared with Ex. 16 to 20 in which a cathode active material having I/r of less than 2.6 is used. In Ex. 16 to 18, the crystallite size r of (110) plane which is a Li diffusion surface is small as compared with Ex. 4. However, of such a cathode active material, the crystallite size of (003) plane is also small, and thus the stability of the crystal structure is low. Accordingly, it is considered that the capacity retention is not sufficiently high.

### INDUSTRIAL APPLICABILITY

The cathode active material of the present invention is suitably used for a lithium ion secondary battery since it can achieve a high discharge capacity and favorable cycle durability.

What is claimed is:

1. A cathode active material represented by LiₐMOₓ (wherein M is an element including at least one member selected from Ni element, Co element and Mn element (other than Li element and O element), “a” is from 1.1 to 1.7, and x is the number of moles of O element required to satisfy the valences of Li element and M),
wherein in an X-ray diffraction pattern, the ratio (I/r) of the crystallite size (I) of (003) plane to the crystallite size (r) of (110) plane assigned to a crystal structure with space group R-3m is at least 2.6.

2. The cathode active material according to claim 1, wherein the molar proportion of Ni is from 10 to 50%, the molar proportion of Co is from 0 to 33.3%, and the molar proportion of Mn is from 33.3 to 85% based on the total amount of the metal elements other than Li contained in the lithium-containing composite oxide.

3. The cathode active material according to claim 1, which is represented by LiₐNi_{α}Co_{β}Mn_{γ}Oₓ (wherein “a” is from 1.1 to 1.7, α is from 0.1 to 0.5, β is from 0 to 0.33, γ is from 0.34 to 0.85, α+β+γ=1, and x is the molar ratio of O element required to satisfy the valences of Li, Ni, Co and Mn).

4. The cathode active material according to claim 1, wherein the crystallite size (I) is from 40 to 200 nm, and the crystallite size (r) is from 5 to 80 nm.

5. The cathode active material according to claim 1, wherein the particle size D₅₀ of the cathode active material is from 3 to 15 μm.

6. The cathode active material according to claim 1, wherein the specific surface area of the cathode active material is from 0.1 to 10 m²/g.

7. The cathode active material according to claim 1, wherein the average particle size of primary particles corresponding to a circle is from 10 to 1,000 nm.

8. The cathode active material according to claim 1, wherein the ratio D₉₀/D₁₀ of the particle size D₉₀ to the particle size D₁₀ of the cathode active material is from 1 to 2.4.

9. The cathode active material according to claim 1, wherein in an X-ray diffraction pattern, the ratio (I₀₂₀/I₀₀₃) of the integrated intensity (I₀₂₀) of a peak of (020) plane assigned to a crystal structure with space group C2/m to the integrated intensity (I₀₀₃) of a peak of (003) plane assigned to a crystal structure with space group R-3m is from 0.02 to 0.3.
